(19) United States
(12) Patent Application Publication
(10) Pub. No.: US 2006/0150457 A1
(43) Pub. Date: Jul. 13, 2006

(54) Badge holder, memo pad and combination badge holder and memo pad

(76) Inventor: Thomas Gerard O'Boyle, Charlotte, NC (US)

Correspondence Address: Adams Evans P.A., 2180 Two Wachovia Center, 301 S. Tryon Street, Charlotte, NC, 28282, US

(21) Appl. No.: 11/033,004

(22) Filed: Jan. 11, 2005

(51) Int. Cl. G09F 3/20

(52) U.S. Cl. 40/658

(57) ABSTRACT

A badge holder for being carried on an article of clothing, such as a belt. The badge holder includes a back cover, a front cover, and a clip. The front cover is attached to the back cover for displaying identifying material. The clip is positioned on the back cover for permitting the badge holder to be releasably secured to a belt or garment.

### TECHNICAL FIELD AND BACKGROUND OF THE INVENTION

This invention relates to a badge holder and more specifically to a badge holder and memo pad having a clip positioned on a back cover for being carried on an article of clothing, such as a belt. Notebooks and badge holders are used to perform various functions.

For example, when attending conventions, conferences, seminars, or the like it is often required that each attendee display information such as his or her name and company affiliation. Typically, this information is printed on a badge. The badge may have an adhesive backing for being attached to an individual's clothing, may be inserted into a badge holder which is pinned or clipped to the individual's clothing, or worn on a chain or cord around the neck. Adhesive badges may not cling to certain fabrics, or may fall off after a period of time. Badge holders that are pinned or clipped to the individual can damage the individual's clothing or come loose and be lost.

Additionally, an attendee may desire to keep notes or record information disseminated at the event. As a result, the individual may carry a notebook and a writing instrument to record this information. Thus, an individual can often be forced to display a badge, carry a notebook, carry a writing instrument, and carry any information or samples distributed at the event.

In another example, golfers and their caddies often carry a notebook and a writing instrument to record information such as distance to a green, scores, or the type of golf club used. The notebook and writing instrument are often placed in a rear trouser pocket, or in a golf bag.

In a further example, engineers working in refineries, power plants, or manufacturing facilities typically carry a notebook to record information or to make drawings. The engineers are often required to climb ladders to reach upper level platforms. As a result, the engineer may be required to climb the ladder with the notebook in one hand, creating a risk of falling.

Accordingly, there is a need for a badge holder and notebook that can be carried on an individual that allows the individual to freely use both hands when needed and displays any required information.

### SUMMARY OF THE INVENTION

Therefore, it an object of the invention to provide a badge holder apparatus that can be secured to an article of clothing and that has an integrally-formed clip on a back cover of the notebook.

It is another object of the invention to provide a badge holder that can be releasably secured to an article of clothing and that has an integrally-formed clip on a back cover of the badge holder.

It is another object of the invention to provide a badge holder that includes a writing instrument holder.

These and other objects of the present invention are achieved in the preferred embodiments disclosed below by providing a badge holder including a back cover; a front cover attached to the back cover for displaying identifying material; and a clip positioned on the back cover for permitting the badge holder to be releasably secured to a belt or garment.

According to another preferred embodiment of the invention, the badge holder apparatus includes paper sheets positioned between the back cover and the front cover to form a memo pad.

According to another preferred embodiment of the invention, the badge holder includes a writing instrument releasably-secured to one or the other of the front cover or back cover.

According to another preferred embodiment of the invention, the writing instrument is secured to the front or back cover by a loop carried on the front cover or back cover.

According to another preferred embodiment of the invention, the loop comprises an elastic material having sufficient expansion to accommodate a writing instrument having a larger diameter than a diameter of the loop.

According to another preferred embodiment of the invention, the back cover is formed from a sheet stock selected from the group consisting of plastic, cardboard, and fiberboard.

According to another preferred embodiment of the invention, the front cover and the back cover are attached to each other by a spiral coil extended through aligned holes in the front cover and back cover.

According to another preferred embodiment of the invention, the clip is a flap formed by a cut in the back cover.

According to another preferred embodiment of the invention, the clip is a spring-biased clamp attached to the back cover.

According to another preferred embodiment of the invention, the clip is a hook attached to the back cover.

According to another preferred embodiment of the invention, the badge holder includes a transparent envelope positioned forward of the front cover for displaying a badge therein.

According to another preferred embodiment of the invention, a combination memo pad and badge holder includes a back cover; a front cover; a binding for binding the front cover and back cover together along a top side edge thereof for movement of the front and back cover relative to each other between an open position providing access to writing paper bound between the front and back covers, and a closed position; a transparent sheet cooperating with the front cover for receiving and displaying a badge; and a clip carried by the back cover for releasable attachment of the back cover to a belt or garment.

According to another preferred embodiment of the invention, the combination memo pad and badge holder includes a writing instrument holder carried by one or the other of the front or back cover.

According to another preferred embodiment of the invention, the writing instrument holder comprises an elastic loop.

According to another preferred embodiment of the invention, a memo pad includes a back cover; a front cover; a binding for binding the front cover and back cover together along a top side edge thereof for movement of the front and back cover relative to each other between an open position providing access to writing paper bound between the front and back covers, and a closed position; and a clip carried by the back cover for releasable attachment of the back cover to a belt or garment.

According to another preferred embodiment of the invention, the memo pad includes a writing instrument holder carried by one or the other of the front or back cover.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is an environmental view of a badge holder being carried on a belt;

FIG. 2 is a perspective view of the badge holder with an attachment clip according to one preferred embodiment of the invention;

FIG. 3 is a perspective view of an embodiment of the badge holder with a spring-biased clamp; and

FIG. 4 is a perspective view of an embodiment of the badge holder with a pre-tensioned clip.

### DESCRIPTION OF THE PREFERRED EMBODIMENT AND BEST MODE

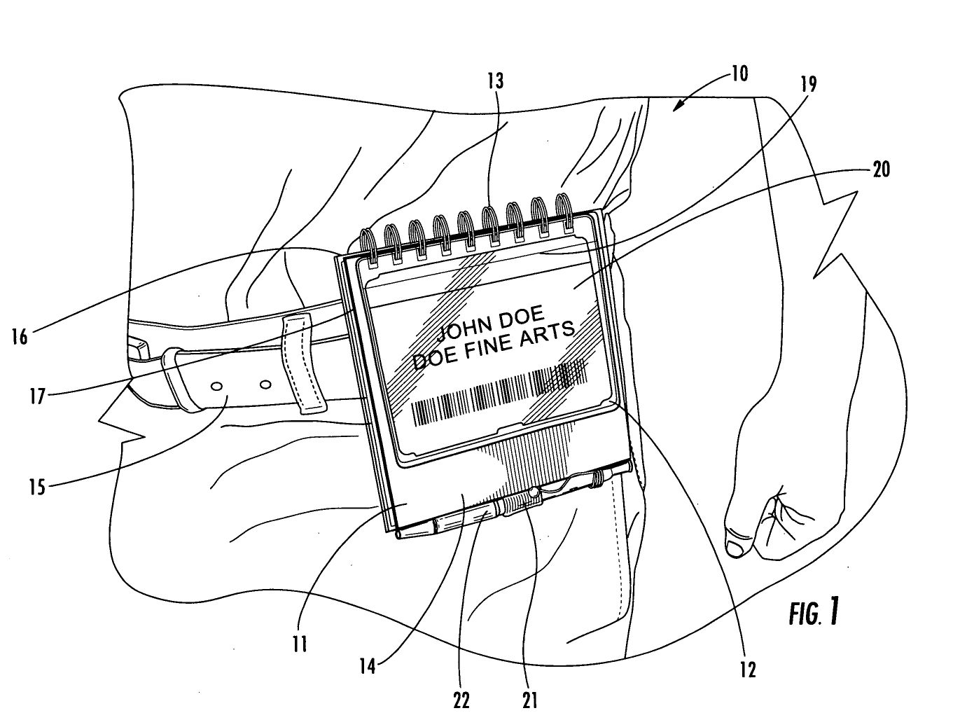

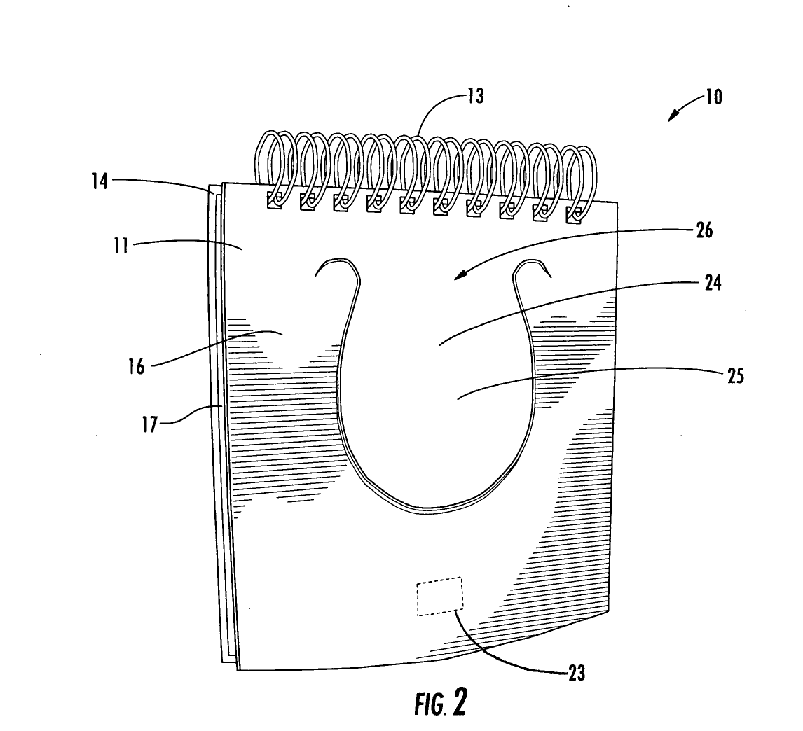

Referring now specifically to the drawings, a badge holder according to an embodiment of the present invention is illustrated in FIGS. 1 and 2 and shown generally at reference numeral 10.

The badge holder 10 is designed to be clipped, for example, to a belt 15, as illustrated, or over the waist or pocket of a garment. The badge holder 10 includes a notebook 11 and a transparent badge holder envelope 12 connected together by a spiral binding 13.

The notebook 11 includes a front cover 14 and a back cover 16. The front 14 and back covers 16 are preferably formed from a semi-rigid sheet stock fabricated from a material such as plastic, cardboard or fiberboard. The notebook 11 includes a plurality of paper sheets 17 positioned between the front 14 and back covers 16. The sheets 17 may include any suitable printed indicia or photographs printed thereon, such as calendar indicia and scorecard indicia, or be left blank for note taking, journaling or recording other types of indicia.

The spiral binding 13 binds the front cover 14, back cover 16, plurality of sheets 17, and badge holder 12 loosely together to permit the covers 14 and 16, sheets 17, and badge holder 12 to be easily moved relative to the spiral binding 13 and to one another.

The badge holder envelope 12 has a slot 19 for allowing a badge 20 to be inserted, and may be loosely connected to the notebook 11 by the spiral binding 13, as illustrated, or may be attached to the front cover 14 by an adhesive or other suitable attachment means. The badge holder envelope 12 may also be used as a front cover for the notebook 11, eliminating the need for the front cover 14.

A pen holder 21 is mounted to the back cover 16 for holding a pen 22 so that the pen 22 is easily accessible for use. The pen holder 21 is preferably a loop formed from a flexible material such as a strip of elastic fabric to allow adequate expansion to permit insertion of the pen 22 and retention under sufficient pressure to retain it against loss, and to accommodate a variety of pen sizes. The pen holder 21 is preferably attached to the back cover 16 using sewing stitches 23 that extend through the pen holder 21 and the back cover 16, or by other suitable attachment means such as hot melt adhesive.

As shown in FIG. 2, the belt holder 10 is secured to the belt 15 by an integrally-formed belt clip 24. The clip 24 is formed by cutting through the back cover 16 to form a horseshoe-shaped flap 25 that remains attached to the back cover by a flexible hinge 26. The clip 24 is thus easily positioned behind the belt 15.

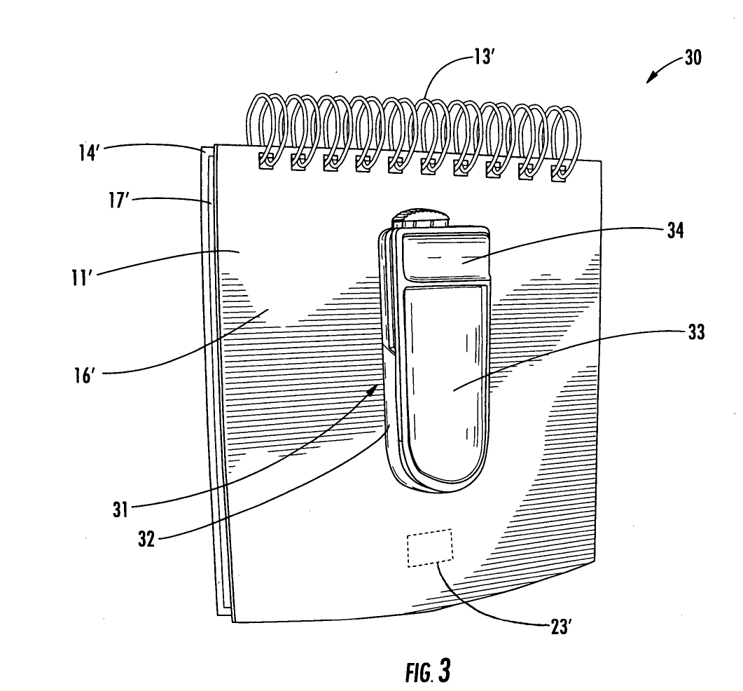

Referring to FIG. 3, in which prime reference numerals indicate like elements to those in FIGS. 1 and 2, a badge holder 30 may alternatively have a spring-biased belt clamp 31. The clamp 31 includes a base 32 and an attached, spring-loaded arm 33. The base 31 is attached to a back cover 16′ of the badge holder 10′ by an adhesive or other suitable fastener such as a rivet (not shown). The clamp 31 is moved from a closed position to an open position by depressing an end 34 of the clamp 31 to create a gap between the base 32 and the clamp 31 and sliding the badge holder 30 over a belt or waistband.

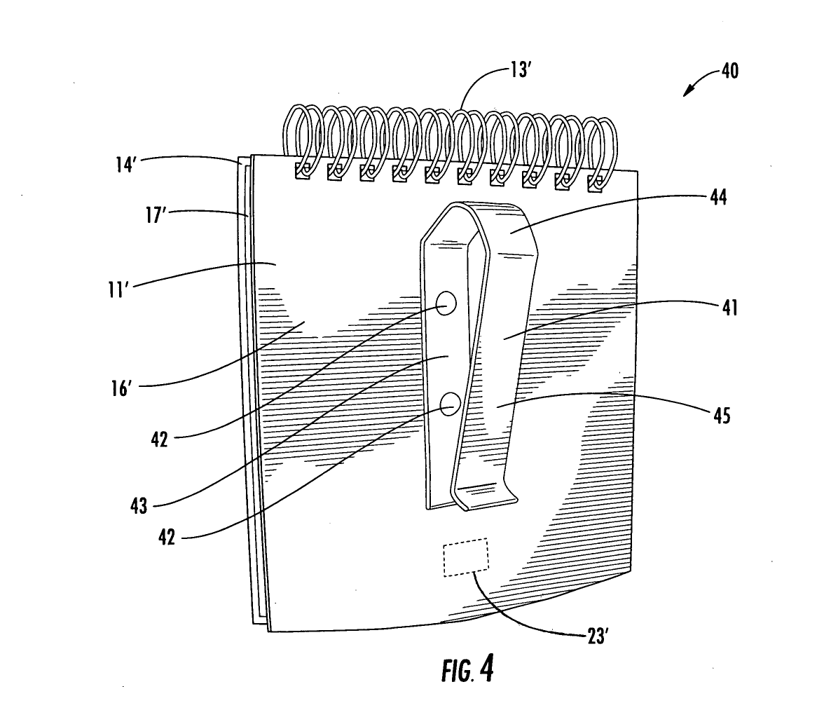

Referring to FIG. 4, in which prime reference numerals indicate like elements to those in FIGS. 1 and 2, a badge holder 40 may alternatively have a one-piece, hook-type belt clip 41 formed of spring steel. The clip 41 includes a substantially flat back segment 43, an arcuate middle segment 44, and a front segment 45 normally tensioned against the back segment 43. The back section 43 is attached to a back cover 16′ of the badge holder 40 by a fastener, such as a rivet 42.

A badge holder is described above. Various details of the invention may be changed without departing from its scope. Furthermore, the foregoing description of the preferred embodiments of the invention and the best mode for practicing the invention are provided for the purpose of illustration only and not for the purpose of limitation, the invention being identified in the claims.

I claim:

1. A badge holder, comprising:
(a) a back cover;
(b) a front cover attached to the back cover for displaying identifying material; and
(c) a clip positioned on the back cover for permitting the badge holder to be releasably secured to a belt or garment.

2. The badge holder according to claim 1, and including paper sheets positioned between the back cover and the front cover to form a memo pad.

3. The badge holder according to claim 1 or 2, and including a writing instrument releasably-secured to one or the other of the front cover or back cover.

4. The badge holder according to claim 3, wherein the writing instrument is secured to the front or back cover by a loop carried on the front cover or back cover.

5. The badge holder according to claim 4, wherein the loop comprises an elastic material having sufficient expansion to accommodate a writing instrument having a larger diameter than a diameter of the loop.

6. The badge holder according to claim 1, wherein the back cover is formed from a sheet stock selected from the group consisting of plastic, cardboard, and fiberboard.

7. The badge holder according to claim 1, wherein the front cover and the back cover are attached to each other by a spiral coil extended through aligned holes in the front cover and back cover.

8. The badge holder according to claim 1, wherein the clip comprises a flap formed by a cut in the back cover.

9. The badge holder according to claim 1, wherein the clip comprises a spring-biased clamp attached to the back cover.

10. The badge holder according to claim 1, wherein the clip comprises a hook attached to the back cover.

11. The badge holder according to claim 1, and including a transparent envelope positioned forward of the front cover for displaying a badge therein.

12. A combination memo pad and badge holder, comprising:
(a) a back cover;
(b) a front cover;
(c) a binding for binding the front cover and back cover together along a top side edge thereof for movement of the front and back cover relative to each other between an open position providing access to writing paper bound between the front and back covers, and a closed position;
(d) a transparent sheet cooperating with the front cover for receiving and displaying a badge; and
(e) a clip carried by the back cover for releasable attachment of the back cover to a belt or garment.

13. The combination memo pad and badge holder according to claim 11, and including a writing instrument holder carried by one or the other of the front or back cover.

14. The combination memo pad and badge holder according to claim 11, wherein the clip comprises an integral flap formed by a cut in the back cover.

15. The combination memo pad and badge holder according to claim 12, wherein the writing instrument holder comprises an elastic loop.

16. The combination memo pad and badge holder according to claim 12, wherein the front cover and back cover are formed from a sheet stock selected from the group consisting of plastic, cardboard, and fiberboard.

17. A memo pad, comprising:
(a) a back cover;
(b) a front cover;
(c) a binding for binding the front cover and back cover together along a top side edge thereof for movement of the front and back cover relative to each other between an open position providing access to writing paper bound between the front and back covers, and a closed position; and
(d) a clip carried by the back cover for releasable attachment of the back cover to a belt or garment.

18. The memo pad according to claim 16, and including a writing instrument holder carried by one or the other of the front or back cover.

19. The memo pad according to claim 16, wherein the clip comprises an integral flap formed by a cut in the back cover.

20. The memo pad according to claim 17, wherein the writing instrument holder comprises an elastic loop.

21. The memo pad according to claim 17, wherein the front cover and back cover are formed from a sheet stock selected from the group consisting of plastic, cardboard, and fiberboard.

22. The memo pad according to claim 17, wherein the clip is a spring-biased clamp attached to the back cover.

23. The memo pad according to claim 17, wherein the clip is a hook attached to the back cover.
